(19) United States
(12) Patent Application Publication
(10) Pub. No.: US 2012/0288335 A1
(43) Pub. Date: Nov. 15, 2012

(54) Soil Stabilization Composition and Methods for Use

(76) Inventor: Rodney Green, Waxahachie, TX (US)

(21) Appl. No.: 13/470,096

(22) Filed: May 11, 2012

Related U.S. Application Data
(60) Provisional application No. 61/485,069, filed on May 11, 2011.

(51) Int. Cl. E02D 3/12; C09K 17/48

(52) U.S. Cl. 405/264; 252/184

(57) ABSTRACT

A soil stabilization composition is provided. The soil stabilization composition includes sulfuric acid, citric acid, phosphoric acid, nonlyphenol90, and water. The soil stabilization composition is capable of changing the molecular charges of swelling clays to resist water absorption rather than to attract water due to the positive/negative charges related to them. This ionic exchange prevents the clay from swelling making the clay more stable to build on.

This application claims the benefit under 35 U.S.C. Section 119(e) of U.S. Provisional Patent Application No. 61/485,069 filed on May 11, 2011 in the United States Patent and Trademark Office entitled “Soil Stabilization Composition and Methods of Use.”

### BACKGROUND

1. Field of the Invention

The present invention relates generally to compositions and methods for soil stabilization and in particular to a novel soil stabilization composition that functions as an ionic exchange agent to change the molecular charges of swelling clays to resist water absorption rather than to attract water which prevents the clay soil from swelling and methods of using same.

There are many different types of soil ranging from sandy to clay. Sandy soils are limited in field surface making water retention difficult. On the other end, clay soils have larger face surfaces allowing the soil particles to absorb water like a sponge. As more water is absorbed the clay expands. Unstable soil is the greatest threat to a foundation. Hundreds of millions of dollars are spent each year for foundation repairs.

For example, when constructing parking lots and roads any paving that is placed on unstable soil is going to move as the soil expands. The underneath movement will create cracks that will lead to costly maintenance repairs. Similarly, a house built on a foundation that is placed on an unstable soil bed is at risk for costly damage and necessary repairs. Finally, pools built in clay soils are also at high-risk of cracks. As the soil moves it can create cracks in the pool or heaving under the deck.

Soil stabilization refers to the process of improving the strength and durability of the underlying soil upon which a structure, such as a road, house, or pool, is built. As a result of the need for soil stabilization, soil stabilization compositions and methods have been created to prevent movement of the underlying soil.

2. Description of Related Art

Within the construction industry, and in particular within the soil stabilization market, soil stabilization compositions and methods have been created to prevent movement of the underlying soil.

Examples of known methods employed in soil stabilization include various methods of compaction, dewatering, and chemical addition to the soil. Because chemical addition to the soil has proven to be the most cost-effective and durable process, those skilled in the art have traditionally relied on chemical stabilization.

Chemical stabilization has traditionally relied on Portland cement and lime for stabilization. However, simply placing a lime base, as is the common practice, does not provide a solution for the soil underneath. Therefore, injection of the chemical has proven to be the most effective means to treat soils with high plasticity. There are three injection methods commonly used in the art. These include chemical injection, lime injection, and water injection.

However, typical chemical injection can be costly because of the process required to inject the chemical and because the most common chemical stabilization agents in the market are not permanent. In addition to being costly, most other soil stabilization chemicals include Naphthalene Sulfonates as a dispersant for the chemical. Naphthalene in large quantities can be hazardous to the environment and to individuals who are exposed to it.

Another disadvantage of existing methods is the use of natural resources. The existing methods use large amounts of water to install and activate the stabilizer, the transportation cost and the emissions involved in all of these aspects have a harmful effect on the environment, and the soils can be saturated in wet climates and permeate to wash away the stabilizers, which then migrate into water sources.

Processes of applying these products are also very messy and unhealthy to the workers and the public. Traditional stabilizers must be applied several times to make the chemical process complete.

A need exists, therefore, for a soil stabilization composition and methods for using same that address the disadvantages of known compositions and methods for soil stabilization.

All references cited herein are incorporated by reference to the maximum extent allowable by law. To the extent a reference may not be fully incorporated herein, it is incorporated by reference for background purposes and indicative of the knowledge of one of ordinary skill in the art.

### BRIEF SUMMARY OF THE INVENTION

The problems presented in existing soil stabilization compositions and methods for using same are addressed by the soil stabilization composition and methods of use of the present invention. In accordance with one embodiment of the present invention, a soil stabilization composition is provided. The soil stabilization composition includes sulfuric acid, citric acid, phosphoric acid, nonlyphenol90, and water. The soil stabilization composition is capable of changing the molecular charges of swelling clays to resist water absorption rather than to attract water due to the positive/negative charges related to them. This ionic exchange prevents the clay from swelling making the clay more stable to build on.

The soil stabilization composition of the present invention is advantageous because it is permanent. The soil stabilization composition of the present invention creates an ionic exchange that changes the molecular structure of the soil. The change of structure then disallows the absorption of water. Regardless of periods of extreme drought or water saturation, the soil stabilization composition of the present invention will remain constant. Since the soil stabilization composition of the present invention is independent of moisture levels, and the injection process can be completed faster than the other injection methods, the soil stabilization composition of the present invention saves time and cost. The soil stabilization composition of the present invention also uses less water than many other known methods of soil stabilization.

Unlike other chemical injections, the soil stabilization composition of the present invention does not burn skin or harm the environment, including vegetation or water sources.

Further, the soil stabilization composition of the present invention has no sulfonated naphthalene or formaldehyde that many other soil stabilization compositions have. The soil stabilization composition of the present invention is organic with earth friendly surfactants. The sulfuric acid percentage is much lower than other known soil stabilization compositions using sulfuric acid making it easier to handle and less corrosive in its diluted form. This makes the soil stabilization composition of the present invention easier on the personnel and the equipment as well as making it safer to transport. Finally, the soil stabilization composition of the present invention costs less than other comparable soil stabilization compositions available on the market.

Other objects, features, and advantages of the present invention will become apparent with reference to the detailed description that follows.

### DETAILED DESCRIPTION OF THE PREFERRED EMBODIMENT

All references cited herein are incorporated by reference to the maximum extent allowable by law. To the extent a reference may not be fully incorporated herein, it is incorporated by reference for background purposes and indicative of the knowledge of one of ordinary skill in the art.

These detailed descriptions of the preferred embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

As described below a soil stabilization composition and methods of use is provided which incorporates quantities of sulfuric acid, phosphoric acid, citric acid, nonylphenol90, and water.

The ideal percentages by weight of the soil stabilization composition of the present invention includes the following:

Sulfuric Acid: 24%

Phosphoric Acid: 10%

Citric Acid: 10%

NonylPhenol90: 3%

While the above percentages by weight are ideal for the soil stabilization composition of the present invention, one skilled in the art will understand that the following ranges of the components of the soil stabilization composition of the present invention can be used without diminishing the qualities or advantages of the present invention.

The following ranges are percentages by weight of the soil stabilization composition of the present invention:

Sulfuric Acid: 18-45%

Phosphoric Acid: 8-15%

Citric Acid: 2-10%

NonylPhenol90: 1-6%

The soil stabilization composition of the present invention is blended in a certain sequence due to the volatile nature of acids. It must be cooled slowly to prevent the breakdown of the product through evaporation.

Sulfuric acid is the ideal ionic exchange agent due to its commercial availability and less cost. Further, because of the affinity of sulfuric acid for water it is an excellent dehydrating agent. Sulfuric acid is also ideal because it has more concentrated hydronium ions than other acids, therefore a soil stabilization composition would require much more hydrochloric or muriatic acid than it does sulfuric acid.

While the percentage by weight of sulfuric acid can be increased, the range provided should not be exceeded due to the corrosive effect on the equipment used to apply the soil stabilization composition.

To blend the soil stabilization composition of the present invention, the sulfuric acid must be added to water because of the exothermic reaction of combining the sulfuric acid with water. Due to this, temperature control may be necessary to by using heat exchangers or chillers. The phosphoric acid and citric acid can be blended at any time during the blending process. The nonylphenol90 should be added below 150 degrees Fahrenheit to prevent burning it up. Cooling times vary as the larger the amount of soil stabilization composition blended, the more heat that is generated, and hence the longer the cooling process.

The soil stabilization composition of the present invention includes water at a ratio of 600 parts to 1 part mixed solution. This soil stabilization composition with aforementioned component percentages by weight and water dilution covers a standard area of 1,750 cubic feet of soil, or 175 square feet to a depth of 10 feet when injected. Emulsion is a 300:1 ratio to prevent drying and may need additional water to be added to the ground to lock the clays.

The soil stabilization composition of the present invention can be pressure injected into the soil. The soil stabilization composition of the present invention is mixed with water at a 600:1 ratio using dosing pumps and injected into the soils up to a 20 foot depth using high pressure pumps achieving pressures up to 250 pounds per square inch on approximately 5 foot centers to ensure complete coverage. If the ground moisture is low an initial pass of water should be injected to open up the fissures and pathways in the soils. Then the soil stabilization composition of the present invention can be injected to lock the soils from expanding.

To inject the soil stabilization composition of the present invention into the soil, a dozer mounted structure will drive multiple hollow injection rods into the ground up to a 20 foot depth. The hollow rods have a point at the end to penetrate through the soil and have multiple holes in a spiral configuration along the length of the rod to achieve a 360 degree pattern of expulsion. The rods are separated approximately 5 feet apart from each other, although one skilled in the art will understand that the spacing of the rods could be altered depending on the composition of the soil and whether less or more soil stabilization chemical was required.

A water source feeds water through a hose going to the pump where the soil stabilization composition of the present invention is introduced into the water stream and then is discharged through a second hose after going through the pump. The second hose feeds the mast where the rods are attached.

Once inserted into the soil, the rods are stopped at 6 inch intervals for saturation to the desired depth, up to 20 feet. The chemical should travel approximately 2.75 feet horizontally to overlap and ensure complete coverage. Injection pressures range from 65 pounds per square inch to approximately 250 pounds per square inch depending on the density of the soil. A chemical metering pump that is operated by an ultrasonic water meter can be used to obtain the proper mixture of the soil stabilization composition of the present invention to water.

Alternate methods to apply the soil stabilization composition of the present invention include a water truck, water wagon, or flooding with pumps. This method is an emulsion to be poured directly on the surface of the soil by soaking the soil up to a depth of 12 inches and blending the soil stabilization composition of the present invention in the soil with a roto mixer or disc.

One skilled in the art will see that the present invention can be applied in many areas where there is a need to provide soil stabilization. For example, the soil stabilization composition of the present invention can be applied to underlying soils for levees, railroad subgrades, city streets, county roads, highways, residential foundations, commercial foundations, swimming pools, decks, athletic tracks, tennis courts, and foundation repair where clays or calcareous shale having high plasticity are present in the soil.

It should be apparent from the foregoing that an invention having significant advantages has been provided. While the invention is shown in only a few of its forms, it is not just limited but is susceptible to various changes and modifications without departing from the spirit thereof.

I claim:

1. A soil stabilization composition for application to soil comprising:
sulfuric acid;
phosphoric acid;
citric acid; and
nonylphenol190.

2. The soil stabilization composition for application to soil according to claim 1 wherein the percentage by weight of sulfuric acid is 24%, the percentage by weight of phosphoric acid is 10%, the percentage by weight of citric acid is 10%, and the percentage by weight of nonylphenol190 is 3%.

3. The soil stabilization composition for application to soil according to claim 1 wherein the percentage by weight of sulfuric acid can be between 18-45%, the percentage by weight of phosphoric acid can be between 8-15%, the percentage by weight of citric acid can be between 2-10%, and the percentage by weight of nonylphenol190 can be between 1-6%.

4. The soil stabilization composition for application to soil according to claim 2 wherein water is mixed with the soil stabilization composition for application to soil at a ratio of 600:1.

5. A soil stabilization composition for application to soil comprising:
24% sulfuric acid by weight;
10% phosphoric acid by weight;
10% citric acid by weight;
3% nonylphenol190 by weight; and
water mixed with the soil stabilization composition for application to soil at a ratio of 600:1.

6. The method of preparing and applying a soil stabilization composition to soil comprising the steps of:
Preparing a soil stabilization composition comprising 24% sulfuric acid by weight, 10% phosphoric acid by weight, 10% citric acid by weight, and 3% nonylphenol190 by weight, mixed with water in a ratio of 600 parts water to 1 part soil stabilization composition, first adding the sulfuric acid to the water while maintaining temperature control, then blending the phosphoric acid and citric acid, and finally adding the nonylphenol190 at a temperature below 150 degrees Fahrenheit;
Using a dozer mounted structure with multiple hollow stainless steel injection rods mounted to a frame, the injection rods having a pointed end to penetrate the soil and having multiple apertures configured in a spiral around the round to ensure a 360 degree expulsion pattern, combined with a water source that feeds water through a hose going to the pump where the soil stabilization composition is introduced into the water stream and then discharged through the injection, to treat the subject soil.

7. The method of preparing and applying a soil stabilization composition to soil according to claim 6 wherein the dozer inserts the injection rods in six inch intervals to a depth of up to twenty feet to ensure saturation of the soil with the soil stabilization composition.
